(19) United States
(12) Patent Application Publication
(10) Pub. No.: US 2009/0234733 A1
(43) Pub. Date: Sep. 17, 2009

(54) Property Management Platform and Method to Generate a tax form

(76) Inventors: Narinder Pal Sandhu, Fremont, CA (US); Pankat Ashwin Shukia, Fremont, CA (US)

Correspondence Address: FURR LAW FIRM, 2622 DEBOLT ROAD, UTICA, OH, 43080, US

(21) Appl. No.: 12/049,272

(22) Filed: Mar. 15, 2008

(51) Int. Cl. G06Q 40/00; G06F 15/16; G06Q 30/00; G06Q 50/00

(52) U.S. Cl. 705/14; 705/31; 709/204

(57) ABSTRACT

The current invention is a web application that will serve the needs of Real Estate investors to minimize their time spent organizing financial information for taxes to maximize return on investment. The application will download transactions from investors financial accounts like bank or credit card, will organize them and will automatically categorize all activities. It will also allow the investor to categorize expenses manually, organize investments, and generate a tax form for tax season. It will allow for the user to edit/add new transactions via e-mail/text messaging from multiple devices. It will also generate automatic alerts that can be communicated to any device like PC, PDA, phone, etc.

### CROSS-REFERENCES TO RELATED APPLICATION(IF ANY)

None

### STATEMENT AS TO RIGHTS TO INVENTION MADE UNDER FEDERALLY-SPONSORED RESEARCH AND DEVELOPMENT (IF ANY)

None

### BACKGROUND OF INVENTION

1. Field of the Invention

The present invention is directed to a method of assisting real estate investors in their tax filing to minimize their time spent organizing papers, more particular a real estate tax application. This application can be used by users as they use T-saps (Tiny, Simple Applications), can work independently to solve specific real estate pain points or in unison to form an integrated experience for real estate investors. The application will download transactions from investors financial accounts like bank or credit card, will organize them and will automatically categorize all activities. It will also allow the investor to categorize expenses manually, organize investments, and generate a tax form for tax season. This application will also allow the user to edit and add new transactions via e-mail/text messaging from multiple devices. It will also generate automatic alerts that can be communicated to any device like PC, PDA, phone, etc.

The platform supports web applications that have inbuilt intelligence to guide an investor.

The platform enables advisors such as real estate agents, brokers, companies, professionals mortgage brokers, lenders, tax advisors, preparers, CPAs, bookkeepers, accountants or anybody who has real estate investors as clients to use it as a marketing tool for an ongoing personal relationship with the real estate investors. The advisors will be able to brand the application, message and communicate with their clients using the applications communication platform. Each T-sap operates independently or in combination to meet customer needs and automatically recommends other T-saps in accord with customer needs. The platform will enable different modes of input devices for interaction such as keyboard, touch-screen, fax, audio, cellphones, pda, etc. and will output information on appropriate displays such as video terminals, e-mail, fax, audio, cellphones etc. (page has a great description of output devices. The platform will also enable collaboration for those who seek assistance through technology.

2. Background

With the world moving at a faster and faster pace and with all the changes with technology and internet a real estate investor needs every tool that they can have available. Few investors are willing to put in significant effort to routinely go through papers and stay on top of their tax information.

Currently in the market there are products that help with taxes, but not specifically for Real Estate investors who wish to put in minimal amount of time each month, rather than spending days organizing information come time to file taxes.

There exists a need for a web tool that will pull relevant data from other web tools, store their applicable information and will allow them to put minimal effort into organizing tax information.

3. Prior Art

U.S. Pat. No. 7,076,452 by Florance, et al. and issued on Jul. 11, 2006, is for a System and method for collection, distribution, and use of information in connection with commercial real estate.

United States Patent Application 20030126052 by Rademaekers, et al. and published on Jul. 3, 2003, is for a Method and apparatus for establishing real estate investments. It discloses a system, method, apparatus, computer program code and means for establishing a real estate investment are provided which include receiving information identifying a user responsible for a new real estate investment, receiving information identifying the new real estate investment, monitoring the received information identifying the new real estate investment for information triggering a trigger event, and causing the transmission, when the triggering event is detected, of a notification message to a designated recipient.

United States Patent Application 20020046159 by Raveis and published on Apr. 18, 2002, is for a System and method for managing transactions relating to real estate. It discloses a system and method for managing real estate transactions. The method includes the steps of receiving and storing data relating to a plurality of contacts including buyers and sellers of real estate, receiving and storing data relating to a plurality of vendors each associated with at least one phase of a real estate transaction, accessing vendor data based upon occurrence of a particular phase of the real estate transaction and communicating data relating to the vendors to a contact upon occurrence of the particular phase of the real estate transaction.

United States Patent Application 20020010674 by Kent and published on Jan. 24, 2002, is for a Method of providing tax credits and property rental and purchase.

There is still room for improvement in the art.

### SUMMARY OF THE INVENTION

The current invention is a web application that will serve the needs of Real Estate investors to minimize their time spent organizing tax information. The application will download transactions from investors financial accounts like bank or credit card, will organize them and will automatically categorize all activities. It will also allow the investor to categorize expenses manually, organize investments, and generate a tax form for tax season. It will allow for the user to edit/add new transactions via e-mail/text messaging from multiple devices. It will also generate automatic alerts that can be communicated to any device like PC, PDA, phone, etc. It will enable advisors such as real estate agents, brokers, companies, professionals mortgage brokers, lenders, tax advisors, preparers, CPAs, bookkeepers, accountants or anybody who has real estate investors as clients to use it as a marketing tool for an ongoing personal relationship with the real estate investors. The advisors will be able to brand the application, message and communicate with their clients using the applications communication platform.

Real Estate Investors want to be efficient with their time and money. This is made possible through the many features of the web application, which allows the user to spend five minutes a month reviewing and editing information instead of spending many days organizing information or spending a thousand dollars to have an accountant organize it.

The platform supports web applications that have inbuilt intelligence to guide an investor when dealing with real estate deduction issues. Each T-sap operates independently or in combination to meet customer needs and automatically recommends other T-saps in accord with customer needs. The platform will enable interaction via multiple devices not limited to keyboard, fax, voice, PDA, and cell phones. The platform will also enable collaboration for those who seek assistance through technology.

Some of the features that will be in the web application will be:
Sample Property—which allows the users to view a sample property already set up;
Review Income & Expenses—which is an overview of monthly income and expenses;
Setup Recurring Income—The application will automatically download intelligently recurring income information once and/or allow the user to enter their expected income once and carries the amount over for the months indicated;
Setup Recurring Expense—The application will automatically download intelligently recurring expense information once and/or allow the user to enter their expected expenses once and carries the amount over for the months indicated; and
Setup Properties—The application will automatically download all information about the property once the address information is entered and/or will allow the user to enter the information
The application will intelligently generate tips for the investor to save money on expenses and/or generate more income. The application will make intelligent recommendations on improving the return on investment. For example, the application will automatically survey the values of the property, intelligently recommend, and create a property tax reduction form. Or the application will survey the rent that should be charged based on an automatic market survey and intelligently make a recommendation that maximizes the rent for the investor.
   Online Marketing Tool for advisors to Real Estate Investors—The application will enable advisors such as real estate agents, brokers, companies, professionals mortgage brokers, lenders, tax advisors, preparers, CPAs, bookkeepers, accountants or anybody who has real estate investors has clients to use it as a marketing tool for an ongoing personal relationship with the real estate investors. The advisors will be able to brand the application, message and communicate with their clients using the applications communication platform.

### GLOSSARY OF TERMS

Browser: a software program that runs on a client host and is used to request Web pages and other data from server hosts. This data can be downloaded to the client's disk or displayed on the screen by the browser.
Client host: a computer that requests Web pages from server hosts, and generally communicates through a browser program.
Content provider: a person responsible for providing the information that makes up a collection of Web pages.
Embedded client software programs: software programs that comprise part of a Web site and that get downloaded into, and executed by, the browser.
Cookies: data blocks that are transmitted to a client browser by a web site.
Hit: the event of a browser requesting a single Web component.
Host: a computer that is connected to a network such as the Internet. Every host has a hostname (e.g., mypc.mycompany.com) and a numeric IP address (e.g., 123.104.35.12).
HTML (HyperText Markup Language): the language used to author Web Pages. In its raw form, HTML looks like normal text, interspersed with formatting commands. A browser's primary function is to read and render HTML.
HTTP (HyperText Transfer Protocol): protocol used between a browser and a Web server to exchange Web pages and other data over the Internet.
HyperText: text annotated with links to other Web pages (e.g., HTML).
IP (Internet Protocol): the communication protocol governing the Internet.
Server host: a computer on the Internet that hands out Web pages through a Web server program.
URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.
UWU server: in connection with the present invention, a special Web server in charge of distributing statistics describing Web traffic.
Visit: a series of requests to a fixed Web server by a single person (through a browser), occurring contiguously in time.
Web master: the (typically, technically trained) person in charge of keeping a host server and Web server program running.
Web page: multimedia information on a Web site. A Web page is typically an HTML document comprising other Web components, such as images.
Web server: a software program running on a server host, for handing out Web pages.
Web site: a collection of Web pages residing on one or multiple server hosts and accessible through the same hostname (such as, for example, www.lucent.com).

### BRIEF DESCRIPTION OF THE DRAWINGS

Without restricting the full scope of this invention, the preferred form of this invention is illustrated in the following drawings:

FIG. 1 illustrates the computer network of the system;

FIG. 2 shows multiple users of the system;

FIG. 3 shows usage and structure of the application;

FIG. 4 displays the page flow of the Property Manager;

FIG. 5 displays the welcome screen;

FIG. 6 displays the overview screen and the communication hub;

FIG. 7 display the summary of the profit and loss screen;

FIG. 8 displays the add property screen for income and expenses;

FIG. 9 displays the recurring income setup screen;

FIG. 10 displays the setup for recurring expenses; and

FIG. 11 displays the central processing system and the Tiny Simple Applications.

### BRIEF DESCRIPTION OF THE PREFERRED EMBODIMENTS

There are a number of significant design features and improvements incorporated within the invention.

The current invention is a web application 1 that will serve the needs of Real Estate investors to minimize their time spent organizing tax information. The application will download transactions from investors financial accounts like bank or credit card, will organize them and will automatically categorize all activities. It will also allow the investor to categorize expenses manually, organize investments, and generate a schedule for tax season. The user will be able to add/edit transactions via email/text messaging from multiple devices. It will also generate automatic alerts that can be communicated to any device like PC, PDA, phone, etc. Advisors to real estate investors will be able use it as a marketing tool for an ongoing personal relationship with their real estate investors. They will also use the application to brand themselves, message and communicate with their clients.

Real Estate Investors want to be efficient with their time and money. This is made possible through the many features of the web application which allows the user to spend five minutes a month reviewing and editing information instead of spending many days organizing information or spending a thousand dollars to have an accountant organize it.

The platform supports web applications that have inbuilt intelligence to guide an investor when dealing with real estate savings and return on investment issues. Each T-sap operates independently or in combination to meet customer needs and automatically recommends other T-saps in accord with customer needs. The platform will enable interaction via multiple devices not limited to keyboard, fax, voice, PDA, and cell phones. The platform will also enable collaboration for those who seek assistance through technology.

Some of the features that will be in the web application will be:
Sample Property—which allows the users to view a sample property already set up;
Review Income & Expenses—which is an overview of monthly income and expenses;
Setup Recurring Income—The application will automatically download intelligently recurring income information once and/or allow the user to enter their expected income once and carries the amount over for the months indicated;
Setup Recurring Expense—The application will automatically download intelligently recurring expense information once and/or allow the user to enter their expected expenses once and carries the amount over for the months indicated; and
Setup Properties—The application will automatically download all information about the property once the address information is entered and/or will allow the user to enter the information
   The application will intelligently generate tips for the investor to save money on expenses and/or generate more income. The application will make intelligent recommendations on improving the return on investment. For example, the application will automatically survey the values of the property, intelligently recommend, and create a property tax reduction form. Or the application will survey the rent that should be charged based on an automatic market survey and intelligently make a recommendation that maximizes the rent for the investor.

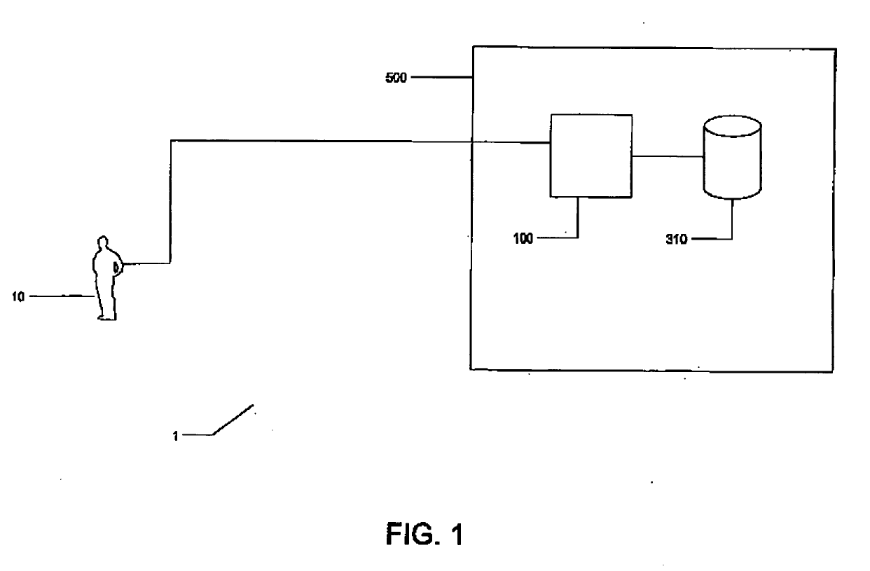

FIG. 1 illustrates a functional diagram of a computer network for World Wide Web 500 access to the System 1 from a plurality of Users 10 who accesses the system Web Site 100 or the Users 10 can connect directly to the System 1. Accessing the System Web Site 100 can be accomplished directly through a communication means such as a direct connection, an intranet, a local Internet Service Provider, often referred to as ISPs, or through an on-line service provider or Wireless devices using services. Each player 10 will have a display device such as a monitor and input device like a keyboard. This display and input device can even be a PDA.

The Users 10 contact the System Web Site 100 using an informational processing system (Client) capable of running an HTML compliant Web browser. A typical system that is used is a personal computer with an operating system running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Users 10 connect to the System 1. The Users 10 will typically be a real estate investor. The system 1 will have a database 310 for the storing of data and code.

Output can include a screen, a graphical user interface, hardcopy, facsimile, e-mail, messaging or other communication with any humanly or machine discernable data and/or artifacts. In some embodiments, output can include transmitting the risk variable related data to a designated recipient, any humanly or machine discernable data and/or artifacts.

The data processing system 1 for both embodiments includes computer processing means for processing data, storage means for storing data on a storage medium, and communication means for transferring data in a secure environment.

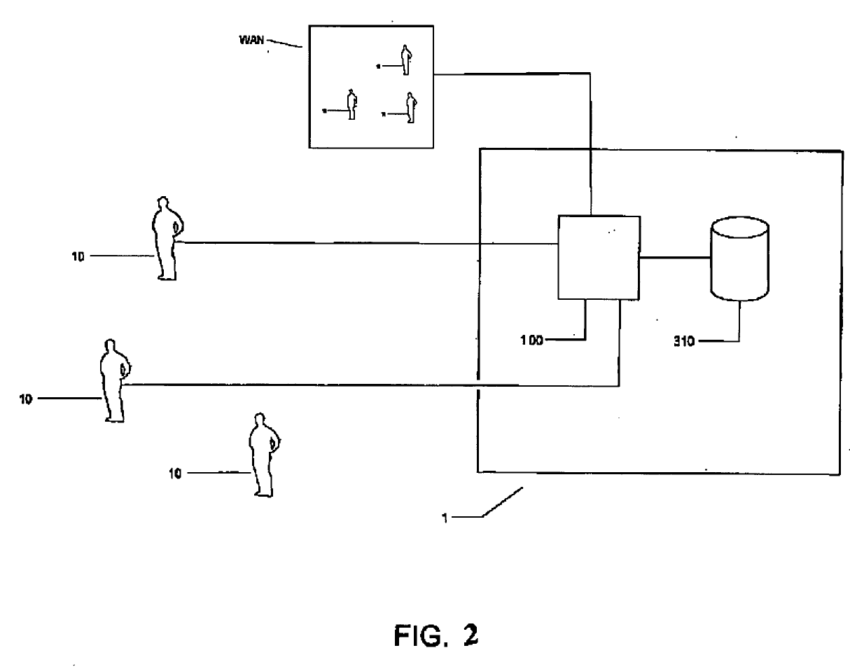

Another embodiment, the system 1 can a stand alone system used by the user 10 loaded on the user's computer or server without the need to connect to the system 1 through the Internet. This embodiment can be connected to multiple Users through a WAN connection as should in FIG. 2.

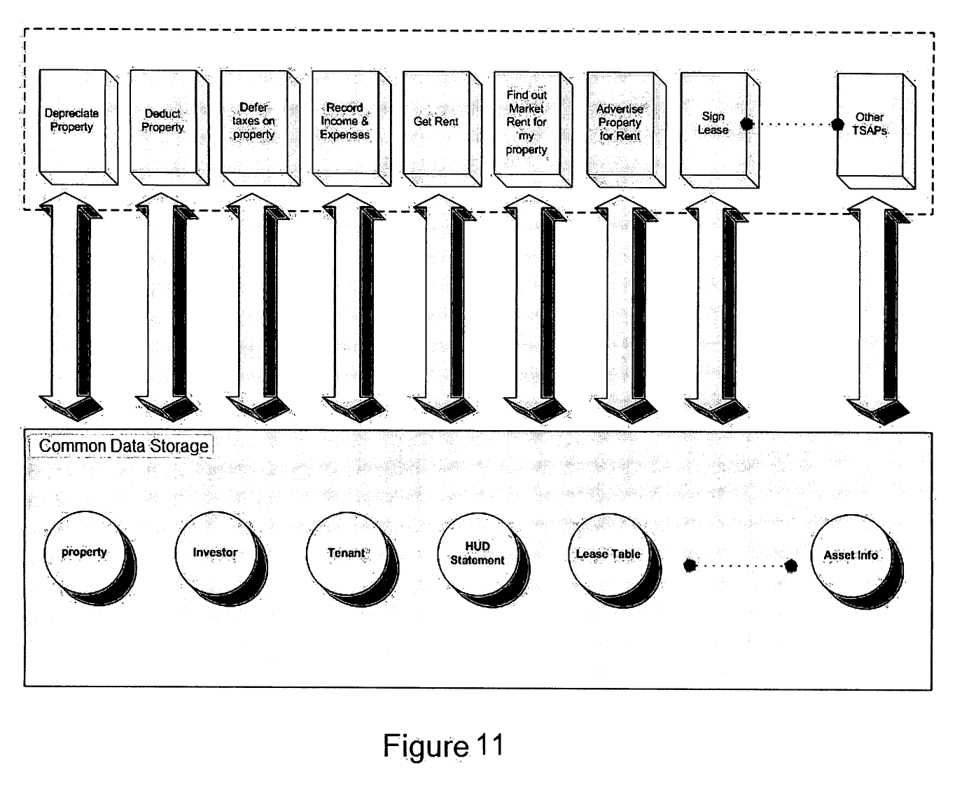

The system 1 is a central processing application 200 which will run system architecture, background and maintenance functions such as database 310 management, logon procedure, security functions and data input and output. The central processing application 20 will manage the running of the Tiny Simple Applications 210 as shown in FIG. 11 and described in earlier related application “Real Estate Web Platform providing intelligent guidance to investors to maximize their returns by enabling them to use tiny-simple applications that can be used standalone or mixed and matched”, application Ser. No. 11/615974 filed Dec. 24, 2006 which is incorporated by reference.

The user 10 will log on to the system 1 using a username and password using generally accepted username and password rules. This username and password will be unique to the user 10.

The system 1 is a central processing application 200 which will run system architecture, background and maintenance functions such as database 310 management, logon procedure, security functions and data input and output.

The central processing application 200 creates a simple, seamless, and integrated experience with multiple. The central processing application 200 selected intelligently based on the needs of the investor.

The system 1 can be written in any computer language that can perform the functions required. Each of the applications can be written in its own language so long as the applications can communicate and transfer data to each other properly. This adds to the flexibility of the system.

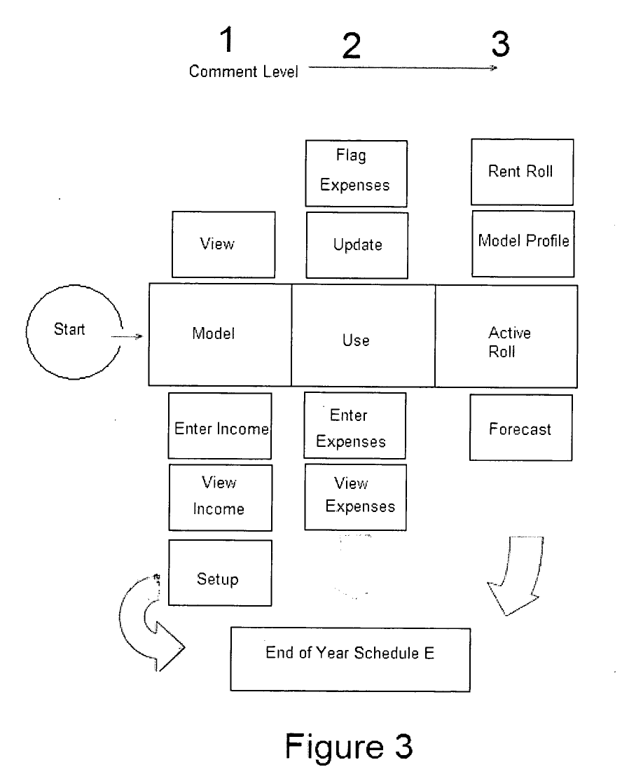

FIG. 3 displays the usage and structure of the system 1. The system 1 is used to generate at the end of the tax year an Internal Revenue Schedule E for the user 10 with minimal effort.

FIG. 3 shows some of the components that are part of the system that go into the creation of the filled out Schedule E. The system 1 has an introduction to the system 1. There is a view income, view expenses, setup property, flag expense, and upload statement. The system 1 can be used to enter income and enter expenses for a single or multiple properties. It will allow you to do a rent roll, to model profits and do planning and forecasting.

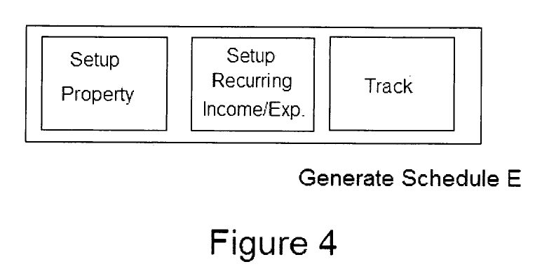

FIG. 4 shows a very high level flow of the application. the setting up of a property. First the User enters a property. The user 10 sets up the recurring monthly income which is split on the basis of category. The user 10 sets up the recurring monthly expenses. The user 10 can track the income and expense per a property or in total. The user can add a one time transaction when one occurs such as a repair bill. The system 1 will allow a user 10 to attach a file to a transaction to track it.

When a user 1 has multiple properties, the system 1 will combine the date on income and expenses on an overview page.

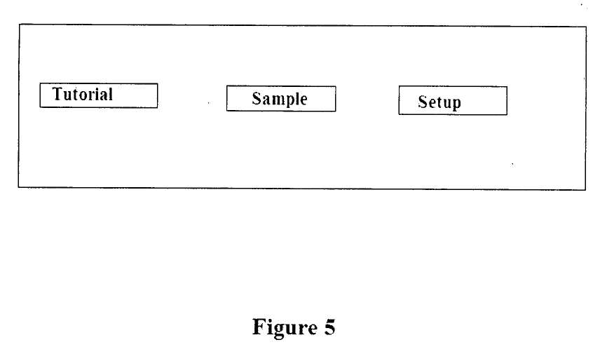

The system 1 is set up to be very user friendly. FIG. 5 is an example of a screen that would pop up for a first time user 10 to assist them with their using of the system.

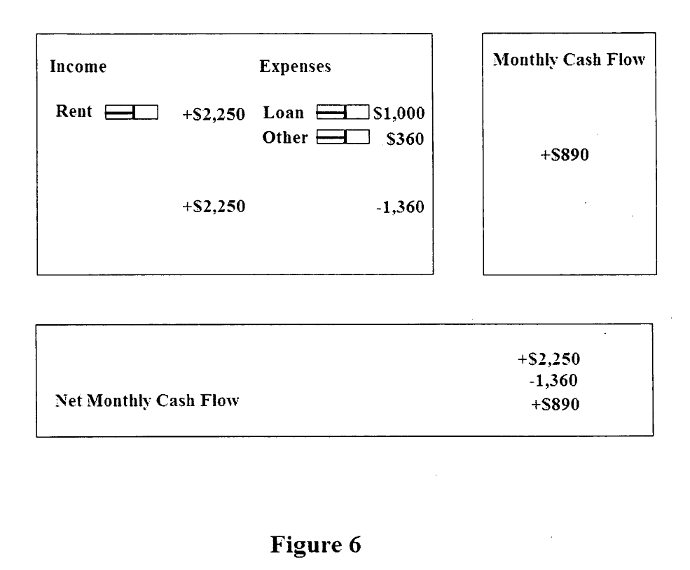

The system 1 will display the overview screen as shown in FIG. 6 which shows monthly cash flow including income per property and expenses and expenses breakdown such as PITI, management expenses, maintenance expenses and utilities. This is also the messaging and communication hub where messages about money saving tips and communication from the professional will be presented.

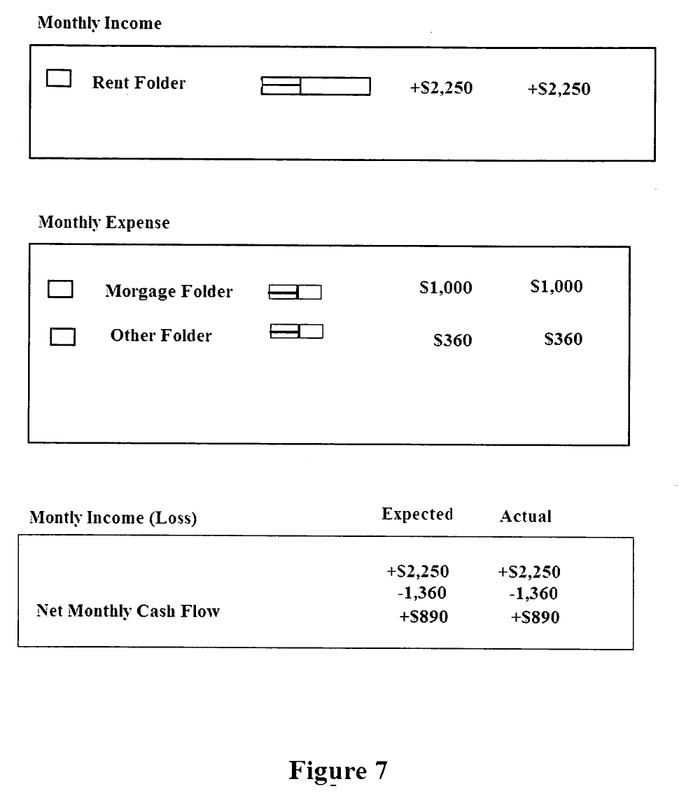

The system 1 will also display the monthly income or loss as shown in FIG. 7. The Monthly Income is displayed as well as the monthly expenses and the new monthly income or loss.

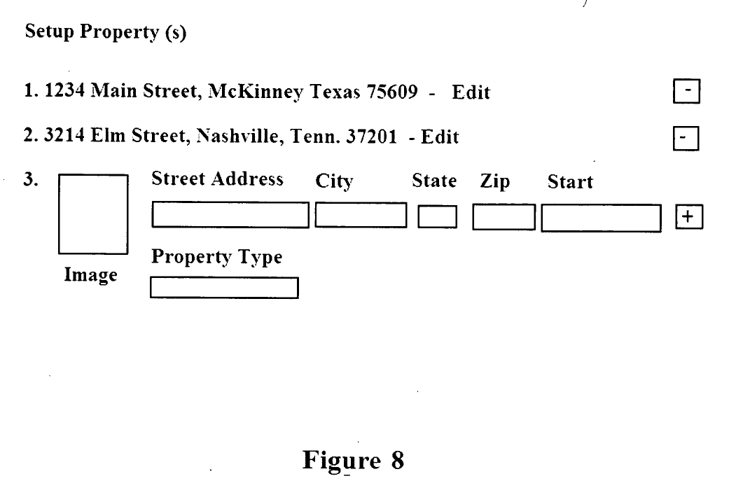

FIG. 8 displays the setup screen to add a new property. The user 10 will input the address of the property and the property type.

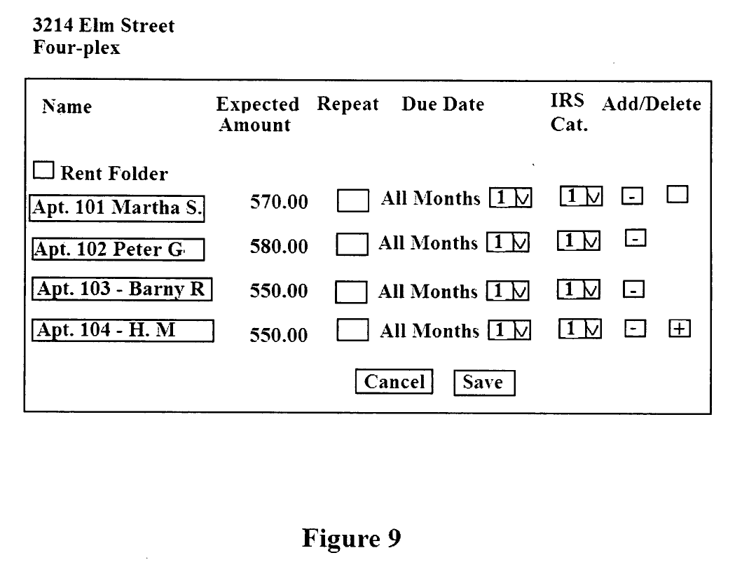

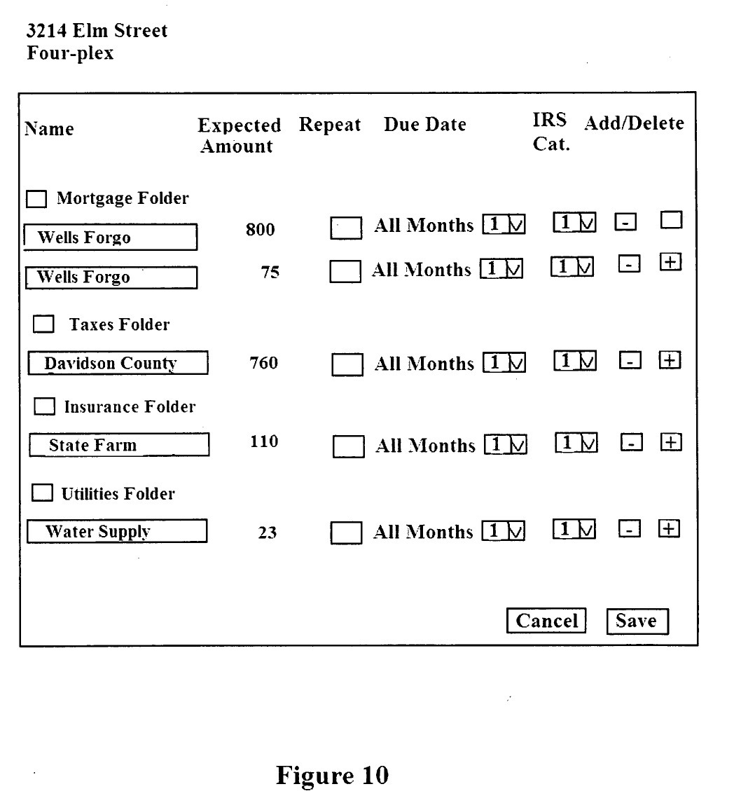

FIG. 9 displays the systems setup screen for recurring income based on individual properties. The user 10 will input the property, the rent received and the due date. While FIG. 10 displays the systems setup screen for recurring expenses.

The system 1 will use the data inputted by the user 10 to fill out the Internal Revenue Services Schedule E for the user 10. It will also allow the user 10 to analyze the portfolio and holding to see how they are doing.

### Advantages

The system is designed to provide tools to help manage investment property and maximize their returns. It is designed to create a destination for small real estate investors to learn from each other. It will create repository of properties for sale and acquisition appropriate to small real estate investor, with tools to help each investor make right buy/sell decisions for their situation.

With the application and system it will not take users more than 5 minutes a month to use the system to review and manage their property income and expenses and it will not take than 30 minutes DIY (do it yourself) or working with an accountant to complete their taxes.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A real estate investor system comprising: having a central processing application and having a user input their income and expenses from a plurality of rental properties and using that information to generate a tax form.

2. A real estate investor system as in claim 1 further comprising automatically categorizing financial transactions from a financial account without user intervention.

3. A real estate investor system as in claim 2 further comprising where said financial account is a credit account.

4. A real estate investor system as in claim 1 further comprising using devices outside of application to receive alerts from system, adding transactions and editing transactions.

5. A real estate investor system as in claim 4 further comprising having said device using E-mail to communicate with the system.

6. A real estate investor system as in claim 4 further comprising using text messaging to communicate with the system.

7. A real estate investor system as in claim 1 further comprising having said system Integrate with a community of investors so that the user can learn from tips from said investors

8. A real estate investor system as in claim 1 further comprising having said tips on how to save money.

9. A real estate investor system as in claim 1 further comprising having said tips on how to get better return on investment (ROI).

10. A real estate investor system as in claim 1 further comprising having said tips on how on specific categories of income/expense related questions on a real estate investment.

11. The system according to claim 1 wherein said system is accessed through the Internet.

12. The system according to claim 1 wherein said system is run on a single computer system.

13. The system according to claim 1 wherein said central processing application is connected to a database.

14. The system according to claim 1 where each of said tiny simple applications will be able to use data collected by other tiny simple applications that have been execute prior to its execution.

15. The system according to claim 1 where each of the tiny simple applications provides guidance to a taxpayer.

16. The system according to claim 1 where a plurality of tiny simple applications can be executed independently.

17. The system according to claim 1 where a plurality of tiny simple applications can be executed any order.

18. The system according to claim 1 where said central processing application manages the database.

19. The system according to claim 1 where said central processing application manages the running of the tiny simple applications.

20. The system according to claim 1 where said central processing application manages the system architecture.

21. A real estate investor system as in claim 1 further comprising enabling advisors to real estate investors to co-brand and use it as a marketing tool for an ongoing personal relations with investors.
